(19) United States
(12) Patent Application Publication
(10) Pub. No.: US 2009/0107423 A1
(43) Pub. Date: Apr. 30, 2009

(54) FUEL REFORMING PROCESS FOR INTERNAL COMBUSTION ENGINES

(76) Inventor: Robert R. Penman, Chestnut Hill, MA (US)

Correspondence Address: BROWN RUDNICK LLP, ONE FINANCIAL CENTER, BOSTON, MA, 02111, US

(21) Appl. No.: 12/015,253

(22) Filed: Jan. 16, 2008

Related U.S. Application Data
(60) Provisional application No. 60/982,204, filed on Oct. 24, 2007.

(51) Int. Cl. F02B 43/10

(52) U.S. Cl. 123/3

(57) ABSTRACT

A fuel reforming system, process, and device including a catalytic chamber and a beating chamber. The catalytic chamber, further including a fluid fuel intake and a gaseous fluid exit port and at least one heat exchanger for distributing heat between the heating chamber and the catalytic chamber. The catalytic chamber further including a screen member having a surface, wherein the member includes a catalytic deposit made from a combination of platinum and rhodium alloy. A catalytic conversion of converting liquid fuel to gaseous fuel occurs within the catalytic chamber. Fuel exits the fuel reforming device through a gaseous fluid exit port.

### CROSS-REFERENCE TO RELATED APPLICATIONS

This patent application claims priority to provisional patent application No. 60/982,204, filed Oct. 24, 2007, the entire contents of which are incorporated herein by reference.

### BACKGROUND

1. Technical Field

The present invention generally relates to internal combustion engines, and more particularly, to a fuel reforming process that improves the efficiency of fuel consumption and reduces environmental pollutants generated by internal combustion engines.

2. Background of the Invention

In response to tightening EPA regulations on automobile exhaust, catalytic converters were introduced to the United States market in the 1970s. Catalytic converters are universally employed in automobile exhaust systems for the reduction of carbon monoxide, hydrocarbons, and oxides of nitrogen. Employed in generator sets, forklifts, mining equipment, trucks, buses, trains, autos, and other engine-equipped machines, catalytic converters provide an environment for a chemical reaction where toxic combustion by-products are converted to less-toxic substances.

Although exhaust catalytic converters remove noxious gases and reduce some green house gases, these devices suffer from several drawbacks. For example, prior art catalytic converters admit spent fuel in a gaseous form rather than a liquid form. Further, the conversion of gases within these devices does not reduce greenhouse pollutants at an efficient rate.

Due to the world's finite supply of fossil fuels, the problems of inefficient catalytic converters must be addressed. For example, if catalytic converters could admit a liquid fuel and convert it into a gaseous fuel product prior to combustion, fuel would burn cleaner resulting in reduced pollution and have a higher combustive power by virtue of increased enthalpy of the converted gaseous product. It would be highly desirable if exhaust catalytic converters in products using fossil fuels, diesel fuels, or aircraft fuels, including liquefied coal, could further reduce greenhouse gas pollutants such as methane, carbon dioxide, and nitrous oxide.

### SUMMARY

Accordingly, a fuel reforming process for internal combustion engines is provided that is easily employed to increase the efficiency of the world's remaining fossil fuels through higher combustive power and increased enthalpy based upon thermodynamic analysis. This fuel reforming process produces a cleaner burning product and removes more greenhouse gas pollutants than prior art. Most desirably, the dissociation of water could produce the perfect fuel by eliminating the need for the exhaust catalytic converter. Theoretically, the products of combustion would only be water vapor, H2 and O. Additionally, green house contamination from combustion could be virtually zero. This process as applied to water, however, will require more experimentation and would require higher temperatures for dissociation than petroleum products and ethanol. The fuel reforming process for internal combustion engines resolves several disadvantages and drawbacks experienced in the art.

In a first aspect, a fuel reforming device is comprised of a catalytic chamber, a heating chamber, a fluid fuel intake and a gaseous fluid exit port. The catalytic chamber includes at least one heat exchanger for distributing heat between the heating chamber and the catalytic chamber. The catalytic chamber further includes at least one screen member that contains a catalytic deposit that is metallurgically clad upon the screen member's surface.

In one embodiment, the catalytic deposit is an alloy comprising platinum and rhodium. A ratio of platinum to rhodium is ideally between 65:35 and 90:10. However, a ratio of 85:15 of platinum to rhodium is highly desirable. In another embodiment, the screen member may be comprised of a non-porous surface that facilitates the catalytic reaction. The catalytic reaction within the fuel reforming device may comprise converting a liquid fuel into a gaseous fuel. The device may also include a thermostat for controlling the temperature within the catalytic chamber. Electrical leads may also attach the thermostat to flow control valves. The flow control valves may also be attached to the heating chamber and may regulate the flow of heat into the catalytic chamber. In another embodiment, at least one heat exchanger distributes heat onto the catalytic chamber.

In a second aspect, a fuel reforming process for converting liquid fuel into gaseous fuel includes passing liquid fuel into the catalytic chamber through the fluid fuel intake port. The process further includes heating the liquid fuel until the maximum catalytic temperature is reached within the catalytic chamber. The liquid fuel is subsequently processed into a gaseous fuel and dispensed from the catalytic chamber through the gaseous fuel exit port.

In one embodiment, the maximum catalytic temperature may be between 400 to 700 degrees Fahrenheit. However, a maximum catalytic temperature between 500 to 600 degrees Fahrenheit is highly desirable.

In another aspect, a system for a fuel reforming device and a fuel reforming process is comprised of a catalytic chamber, a heating chamber, at least one heat exchanger, and a screen member. The catalytic chamber houses the conversion of liquid fuel into gaseous fuel as the liquid fuel is passed into the catalytic chamber. The system includes a heating chamber that provides heat to facilitate the conversion of liquid fuel into gaseous fuel within the catalytic chamber. The liquid fuel is heated until a maximum temperature is reached to facilitate the conversion of liquid fuel into gaseous fuel. The catalytic chamber includes at least one heat exchanger for distributing heat between the heating chamber and the catalytic chamber. This process occurs as liquid fuel is processed as it contacts a screen member which has a surface that contains a catalytic deposit.

In one embodiment, the catalytic deposit is an alloy comprising platinum and rhodium. The ratio of platinum to rhodium is substantially 85:15. In another embodiment, at least one heat exchanger distributes heat into the catalytic chamber until a maximum temperature of 500 to 600 degrees Fahrenheit is substantially attained for converting the liquid fuel into the gaseous fuel.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a side view of the fuel reforming chamber;

FIG. 2 is a top view of the fuel reforming chamber;

FIG. 3 is an inlet end view of the fuel reforming chamber;

FIG. 4 is a partial end view section of the fuel reforming chamber;

FIG. 5 is a front and side view of the heat jacket caps;

FIG. 6 is a front and side view of the fuel chamber caps;

FIG. 7 is a front and side view of the heat exchanger and screen member;

FIG. 8 is a cross-sectional side view of the tubing and milled slots; and

FIG. 9 is a perspective view of the tubing and a platinum/rhodium screen member.

### DETAILED DESCRIPTION OF EXEMPLARY EMBODIMENTS

The present invention is directed towards a fuel reforming device for internal combustion engines, which are discussed in terms of internal combustion engines, and more particularly, to a fuel reforming process that increases fuel efficiency and reduces green house gas pollutants. The following discussion includes a description of the fuel reforming process, system, and device for internal combustion engines. Reference will now be made in detail to exemplary embodiments of the disclosure, which are illustrated in the accompanying figures.

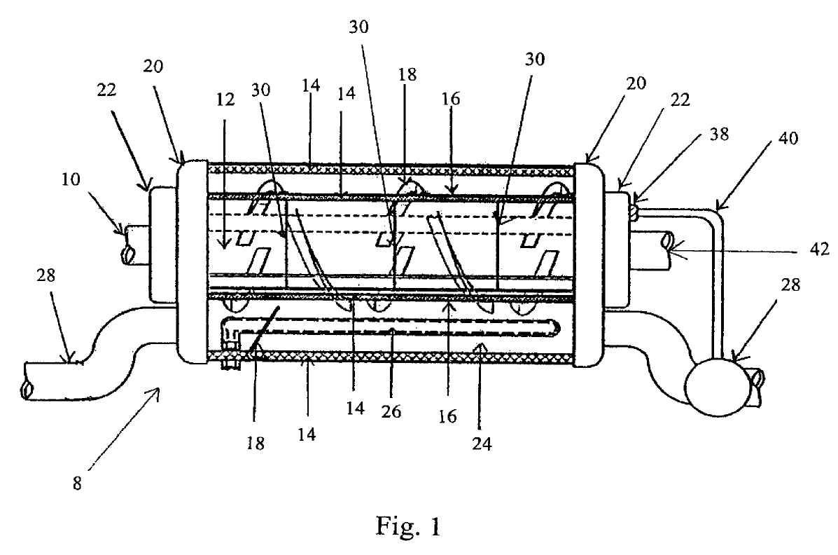

Referring to FIG. 1, a fuel reforming device 8 is designed to convert a liquid fuel that is passed from a fuel filter into a gaseous fuel prior to entering an engine's fuel injectors. The present disclosure is significantly smaller in size and is contained in comparison to prior art. The fuel reforming device 8 is installed onto injectors (not shown in the figures) to perform this process.

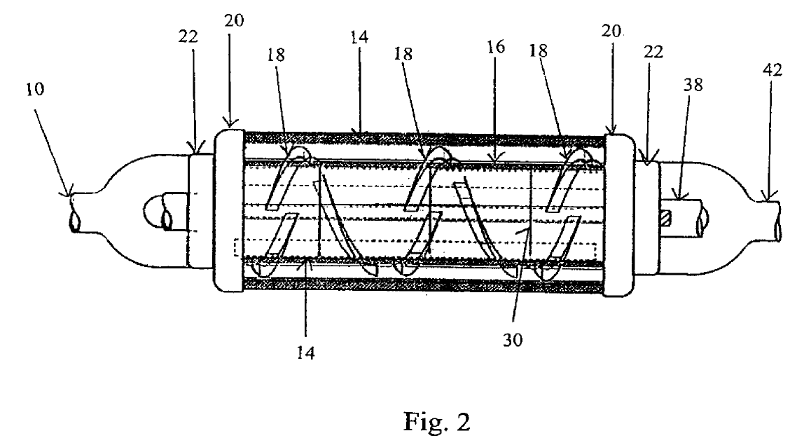

Referring to FIGS. 1-2, the liquid fuel exits the fuel filter and enters a fluid fuel entry port 42. The fluid fuel entry port 42 is a passage that directly connects the fuel filter to a catalytic chamber 12. Within the fluid fuel entry port 42, fuel passes in an undisturbed liquid state by force of external pressure into the catalytic chamber 12. The catalytic chamber 12 is a structure where a catalytic conversion of liquid fuel into gaseous fuel takes place. The choice of materials to construct the catalytic chamber 12 is dependant upon the temperature required for the catalytic conversion. Any material that is capable of withstanding high degrees of temperature is suitable for the catalytic chamber 12. Materials such as stainless steel metals are generally preferred. However, other embodiments may use different metals or other materials to create the catalytic chamber 12.

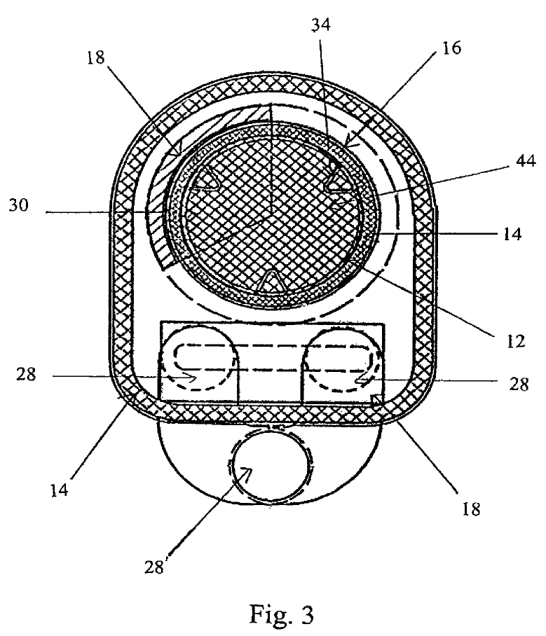

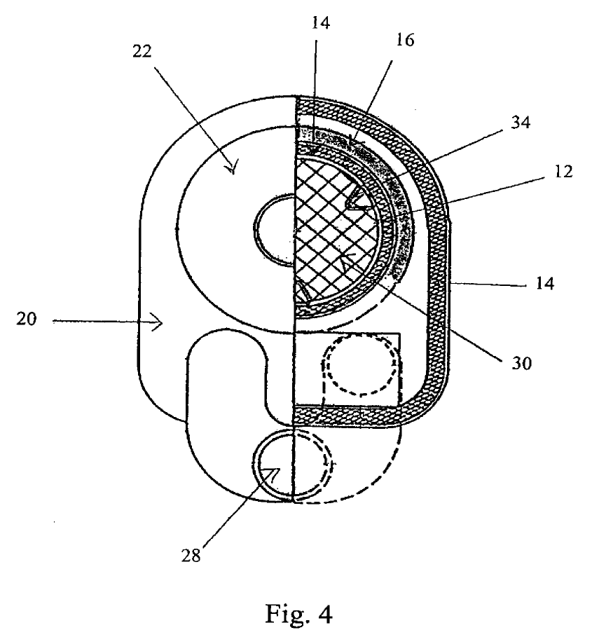

Referring to FIGS. 1-4, the catalytic chamber 12 includes a screen member 30. The catalytic conversion of liquid fuel into gaseous fuel occurs as liquid fuel passes over and through the screen member 30. It is contemplated that the screen member 30 may be a screen or other configuration that provides a surface which can support a catalyst deposit 44. It is well known in the art that catalysts are required to facilitate the conversion of liquid fuel into gaseous fuel. In a preferred embodiment of this invention, the surface of the screen member 30 is flat and burr free as a result of a metal forming process such as “fine blanking” and is metallurgically clad with an alloy of platinum and rhodium. The ratio of platinum and rhodium is ideally between sixty-five to thirty-five (65:35) and ninety to ten (90:10). However, a ratio of eighty-five to fifteen (85:15) of platinum and rhodium is preferable. Other embodiments may include additions to replace and dilute either, or both, the alloy of platinum and rhodium with elements such as Iridium, Gold, Palladium, Silver, Copper, with small additions of trace elements such as Strontium, Actinium, Thorium, Cesium, Thulium, and Ytterbium.

The screen member 30 preferably provides a non-porous surface whereupon a catalytic deposit 44 may clad. Non-porous materials (i.e., stainless steel wire of 304 series class) are ideal for cladding. In one particular embodiment, the clad may range from 0.0002″ to 0.0003″ of an inch thickness on stainless steel wire ending at 0.015″ to 0.018″ diameter. It is well known in the art that other embodiments may achieve similar results with any measurements of alloy thickness. Prior art catalytic converters use platinum and rhodium alloy deposited over a ceramic honeycomb surface for support. These catalytic converters, however, are incapable of facilitating a liquid fuel to gaseous fuel conversion due to clogging and the possibility of dirt and dust admitted into the combustion system.

The catalytic conversion of a liquid fuel to a gaseous fuel requires an environment that can maintain high degrees of temperature. Heat insulating materials may surround the catalytic chamber 12. A ceramic lining 14 is a type of heat insulating material that is suitable for this purpose. Other materials that can act as heat insulators may be used in this device. These heat insulating materials should resist spalling and cracking from thermal shock and handling.

An outer shell 16 may surround the catalytic chamber 12. The ceramic lining 14 may line the interior of the outer shell 16. The outer shell 16 may be comprised of, but is not limited to, materials such as stainless steel. A heat exchanger 18 may be secured to the outer shell 16 through methods such as spot welding. It is well known in the art that the heat exchanger 18 may be secured to the outer shell 16 through alternative means. It is contemplated that the heat exchanger 18 may be, but is not limited to, materials such as baffle segments, barriers, and fins. At least one heat exchanger 18 may attach to the outer shell 16 and can act as a circulation path for heat, through conduction, within the catalytic chamber 12.

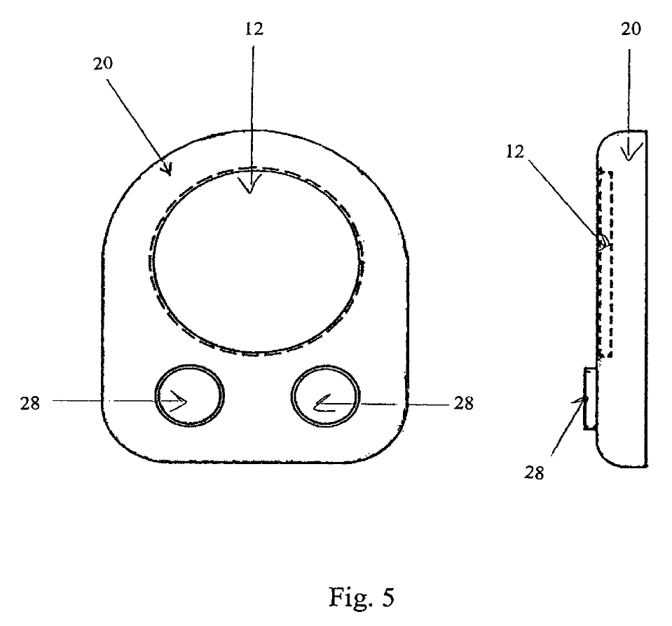

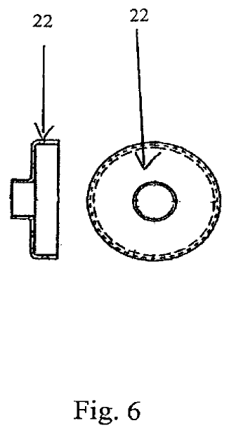

Referring to FIGS. 1-6, heat jacket caps 20 retain the catalytic chamber 12 in alignment. The fuel chamber caps 22 clamp the heat jacket caps 20 and the catalytic chamber 12 assemblies together and form a hermetic seal. The heat jacket caps 20 and fuel chamber caps 22 may be composed of materials such as stainless steel and may be coated with a high temperature cement.

Liquid fuel is heated beyond its standard operating temperature by a heating chamber 24 located above and below the catalytic chamber 12. The heating chamber 24 contains an auxiliary electric heating element 26 and the heat exchanger 18 to deflect heat to the catalytic chamber 12. The ceramic lining 14 may serve as heat insulation and surround the heating chamber 24 to maintain the temperature within the heating chamber 24.

Heat is directed by force of external pressure into the heating chamber 24 from a flow control valve 28 located below the fluid fuel entry port 42. The flow control valves 28 may disburse heat emitted from an automobile engine exhaust manifold to the heating chamber. This heat may be directed upward by the heat exchanger 18 to distribute the heat uniformly over the catalytic chamber 12. The totality of heat emitted by the heat chamber 24 and the flow control valve 28 is insufficient to reach the required temperature for the catalytic conversion. It is well known in the art that a temperature substantially within the range of 400 to 700 degrees Fahrenheit is required to facilitate a catalytic conversion of liquid fuel to gaseous fuel. However, other end temperature ranges as would be understood in the art may facilitate a catalytic conversion and therefore, is contemplated herein.

A thermostat 38 may gauge the temperature of the catalytic chamber 12. Heat exchanger 18 circulates heat around the catalytic chamber 12 to achieve a preferred maximum catalytic temperature of 500 to 600 degrees Fahrenheit for the catalytic conversion. A pair of leads 40 may attach the thermostat 38 to the flow control valve 28. The leads 40 may send an electrical current from the thermostat 38 to the flow control valve 28 when chamber temperature is substantially between 500 to 600 degrees Fahrenheit. The flow of hot air from the flow control valve 28 into the heating chamber 12 will be ceased upon achieving the required temperature.

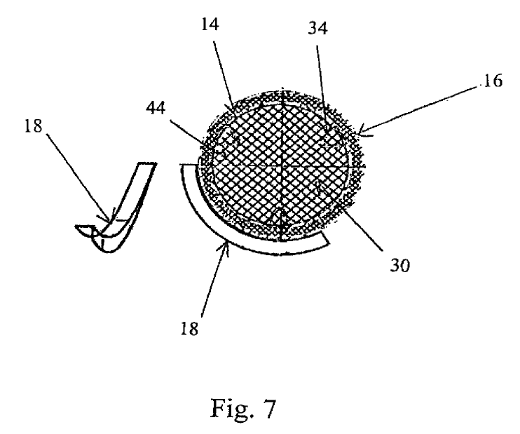

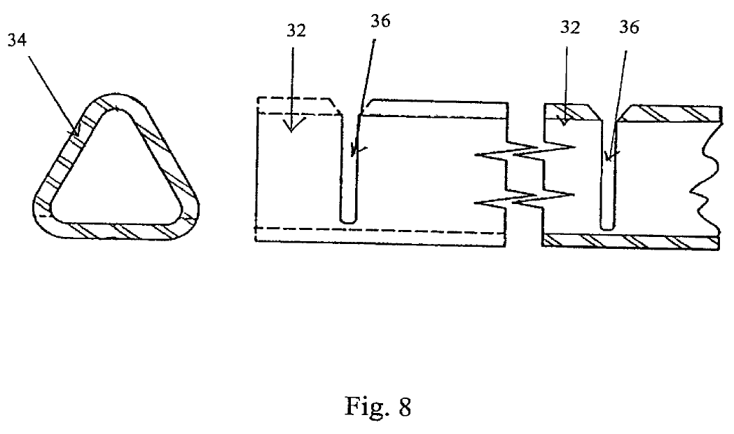

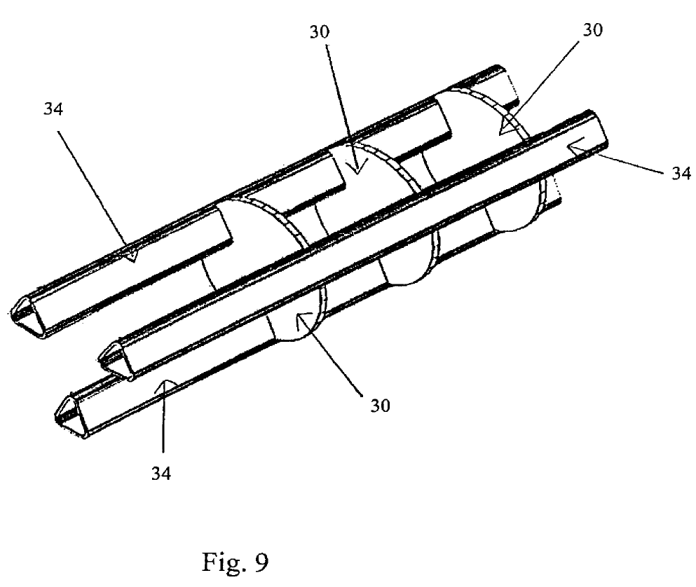

Referring to FIGS. 1-9, the screen member 30 may be secured by spacer sleeves 32. The spacer sleeves 32 separate and clamp the screen member 30 in position to prevent movement during the catalytic conversion. The spacer sleeves 32 may be made from tubing 34 and may be composed of stainless steel. It is also possible to design the spacer sleeves 32 in other shapes such as circular, oval, rectangular, or polygonal. The tubing 34 may accommodate one or more screen members 30. Milled slots 36 are located throughout the spacer sleeves 32 to ensure the screen member 30 fits snuggly. The number and spacing of the milled slots 36 may be determined by the specific size of the catalytic chamber 12 and the number of screen members 30 required. The width of milled slots 36 may be determined by the thickness of the screen member 30.

The catalytic reaction of converting liquid fuel to gaseous fuel occurs at a temperature of 500 to 600 degrees Fahrenheit as the liquid fuel passes through the screen member 30 and contacts the catalytic deposit 44. Internal pressure develops within the catalytic chamber 12 and moves the liquid fuel across the screen members 30. Fuel exits the catalytic chamber 12 in a gaseous state through the gaseous exit port 10. The gaseous exit port 10 transports gaseous fuel to injectors.

External batteries may be used as a source of energy to facilitate the catalytic conversion. For example, lithium-ion batteries or solar energy sources either on the roof of vehicles, outside on the roof of a home for household purposes, or power generators are one of many possible energy sources in the event an automobile's standard battery is inadequate. This external battery would supply power to the auxiliary electric heating element 26.

The present description will have a higher octane number than the original fuel in prior art, which will allow for a spark-ignited Otto cycle with a higher compression ratio, thereby improving efficiency. Such gains could ultimately increase the world's finite fuel supply from a minimum of 5% to the order of 20%+over the next twenty five to thirty years while producing a cleaner burning product which reduces pollution of the environment and favorably influence global warming and health issues. Thermodynamic analysis has shown that the enthalpy of the catalytic gaseous product is increased. Furthermore, the fuel reforming process could increase the marketability of vehicles through greater ease of compliance with fuel standards such as CAFE.

The present description will also result in decreased fuel consumption, while creating lowered gaseous byproducts in each power stroke in the combustion cycle. Thus, reducing noxious gases and carbon particles in the exhaust stroke in the combustion cycle. The reduction of soot would be particularly advantageous to the aircraft industry and diesel fuel users reducing environmental hazards overall. As a result of these advantages, the miles per gallon of fuel would also increase significantly, reducing the world's demand on the limited supply of fossil fuels. This would produce a large economic stimulus to business and households in general. Additionally, these results would be of great advantage for automotive products, aircraft and off road vehicles.

The present invention could also improve more efficient use of liquid fuels in operations, such as oil fired burner equipment used for home heating and power plant electrical generating systems. These applications will also require additional energy input to keep the catalytic chamber 12 hot enough to carry out the conversion reaction, such as, for example, a solar power assist mechanism.

The dissociation of water could produce the perfect fuel by eliminating the need for the exhaust catalytic converter. Theoretically, the products of combustion would only be water vapor, H2, and O. Additionally, green house contamination from combustion would be virtually zero. The present invention reduces green house gas pollutants from present day liquid petroleum fuels and potentially liquefied coal products. This process, as applied to water, however, will require more experimentation, and would require higher temperatures for dissociation than petroleum products and ethanol.

It will be understood that various modifications may be made to the embodiments disclosed herein. Therefore, the above description should not be construed as limiting, but merely as exemplifications of the various embodiments of the invention. Those skilled in the art will envision other modifications within the scope and spirit of the claims appended hereto.

What is claimed is:

1. A fuel reforming device comprising:
a catalytic chamber;
a heating chamber;
a fluid fuel intake and a gaseous fluid exit port in communication with the catalytic chamber;
the catalytic chamber including at least one heat exchanger for distributing heat between the heating chamber and the catalytic chamber; and
the catalytic chamber including a screen member having a surface, wherein the screen member includes a catalytic deposit on the surface.

2. A fuel reforming device of claim 1, wherein the catalytic deposit is an alloy comprising platinum and rhodium.

3. A fuel reforming device of claim 2, wherein the platinum to rhodium ratio of the alloy is substantially between 65:35 and 90:10.

4. A fuel reforming device of claim 3, wherein the platinum to rhodium ratio of the alloy is substantially 85:15.

5. A fuel reforming device of claim 1, wherein the screen member presents a non-porous surface that facilitates a catalytic reaction.

6. A fuel reforming device of claim 5, wherein the catalytic reaction is converting a liquid fuel into a gaseous fuel.

7. A fuel reforming device of claim 1, further including a thermostat controlling the temperature of the catalytic chamber.

8. A fuel reforming device of claim 7, wherein the at least one heat exchanger distributes heat within the catalytic chamber until a maximum temperature is attained.

9. A fuel reforming device of 7, wherein leads attach the thermostat to a flow control valve.

10. A fuel reforming device of claim 9, wherein the flow control valve regulates the flow of heat into the catalytic chamber.

11. A fuel reforming device of claim 9, wherein the flow control valve is attached to the heating chamber.

12. A fuel reforming process for converting a liquid fuel into a gaseous fuel comprising:
passing the liquid fuel into a catalytic chamber through a fluid fuel intake port;
heating the liquid fuel until a maximum temperature within the catalytic chamber is attained;
processing the liquid fuel by way of a catalytic conversion into the gaseous fuel; and dispensing the gaseous fuel from the catalytic chamber through a gaseous fuel exit port.

13. A fuel reforming process of claim 12, wherein the maximum temperature is substantially between 400 and 700 degrees Fahrenheit.

14. A fuel reforming process of claim 13, wherein the maximum temperature is substantially 500 to 600 degrees Fahrenheit.

15. A system for a fuel reforming device and a fuel reforming process comprising:
a catalytic chamber for housing the conversion of a liquid fuel into a gaseous fuel by passing the liquid fuel into the catalytic chamber;
a heating chamber for providing heat to facilitate the conversion of the liquid fuel into the gaseous fuel within the catalytic chamber, wherein the liquid fuel is heated until a maximum temperature is reached to facilitate the conversion of the liquid fuel into the gaseous fuel;
at least one heat exchanger for distributing heat between the heating chamber and the catalytic chamber, wherein the heated liquid fuel is passed through a screen member having a surface containing a catalytic deposit and processed by way of a catalytic conversion into the gaseous fuel;

16. A system of claim 15, wherein the catalytic deposit is an alloy comprising platinum and rhodium.

17. A system of claim 16, wherein the platinum to rhodium ratio of the alloy is substantially 85:15.

18. A system of claim 15, wherein the at least one heat exchanger distributes heat within the catalytic chamber until the maximum temperature of 500 to 600 degrees Fahrenheit is substantially attained for converting the liquid fuel into the gaseous fuel.
